(19) United States
(12) Patent Application Publication
(10) Pub. No.: US 2018/0215575 A1
(43) Pub. Date: Aug. 2, 2018

(54) SUSPENDED SURFACE ASSEMBLY AND A METHOD FOR DEPLOYING SAME

(71) Applicant: Tait Towers Manufacturing, LLC, Litilz, PA (US)

(72) Inventor: Adam DAVIS, Leola, PA (US)

(21) Appl. No.: 15/723,493

(22) Filed: Oct. 3, 2017

Related U.S. Application Data
(60) Provisional application No. 62/406,711, filed on Oct. 11, 2016.

(51) Int. Cl. B65H 75/28; G03B 21/43; G03B 21/58; B65H 75/24; B65H 23/18; G03B 21/32; B65H 23/198

(52) U.S. Cl. CPC B65H 75/28; G03B 21/43; G03B 21/58; G09F 19/18; B65H 23/1813; G03B 21/321; B65H 23/198; B65H 75/246

(57) ABSTRACT

A suspended surface assembly is provided having a trainable surface support element, a spindle component configured for training of the trainable surface support element therearound, a take-up action module configured to drivingly rotate the spindle component to thereby effect winding of the trainable surface support element onto the spindle component or to effect unwinding of the trainable surface support element from a partially or fully wound-up condition, and a lift complex for adjusting the vertical position of the trainable surface support element and the spindle component, the lift complex including a motive power element operable to both drivingly rotate the spindle component and to drivingly raise and lower the trainable surface support element and the spindle component. A method for operating the suspended surface assembly is also provided.

### BACKGROUND OF THE INVENTION

A motorized roll drop arrangement is commercially offered under the brand name “PanaVista 3” by Formance, Inc. As seen in FIG. 11 and FIG. 12, each of which is a graphic image of this product, this commercially available roll drop arrangement provides a screen that can be wound onto, and unwound from, a core. The winding and unwinding of the screen is effected via a motor coupled to the rotatable core. The motor is supported on a frame adjacent an axial end of the core.

While the above-noted motorized roll drop arrangement may provide satisfactory winding and unwinding of the screen, it would be advantageous to have a configuration wherein the core and the screen of a roll drip arrangement can be vertically displaced in addition to having a capability that the screen can be wound onto, and unwound from, the core.

U.S. Pat. No. 9,162,791 to Gartrell, III discloses that live performances in a theater typically employ a number of curtains and backdrops to convey to the audience different settings, environments, moods, and the like. These curtains and backdrops must be changed throughout the course of a performance within a fairly short time frame without interrupting the performance. Typically this is done by raising a particular backdrop above the stage and out of sight of the audience when it is not being used. When a particular backdrop is needed, it is lowered into place on the stage. U.S. Pat. No. 9,162,791 to Gartrell, III notes that theatrical backdrops and curtains are typically suspended from battens, which are pipes or trusses that span the width of the stage. Battens can be 20 feet or more in length, depending on the size of the stage. As should be apparent, the weight of the battens and the items suspended from them can have substantial weight. As the weight of the load increases, so does the power required to raise the load.

Therefore, there is an unmet need to provide a suspended surface assembly and a method for deploying such a suspended surface assembly that may offer more flexibility in configuring and deploying suspended surfaces such as, for example, olios and scrim curtains often deployed in theater and performance environments, and that may offer opportunities for reducing the weight and inertial mass of deployed components.

### BRIEF DESCRIPTION OF THE INVENTION

The present invention relates, in one aspect thereof, to a suspended surface assembly. The suspended surface assembly has a trainable surface support element, a spindle component configured for training of the trainable surface support element therearound, a take-up action module configured to drivingly rotate the spindle component to thereby effect winding of the trainable surface support element onto the spindle component or to effect unwinding of the trainable surface support element from a partially or fully wound-up condition, and a lift complex for adjusting the vertical position of the trainable surface support element and the spindle component, the lift complex including a motive power element operable to both drivingly rotate the spindle component and to drivingly raise and lower the trainable surface support element and the spindle component.

The present invention relates, in another aspect thereof, to a method for deploying such a suspended surface assembly. The method includes providing a suspended surface assembly having a trainable surface support element, a spindle component configured for training of the trainable surface support element therearound, a take-up action module configured to drivingly rotate the spindle component to thereby effect winding of the trainable surface support element onto the spindle component or to effect unwinding of the trainable surface support element from a partially or fully wound-up condition, and a lift complex for adjusting the vertical position of the trainable surface support element and the spindle component, the lift complex including a motive power element operable to both drivingly rotate the spindle component and to drivingly raise and lower the trainable surface support element and the spindle component.

An advantage of the present disclosure is the ability to have a flexible display component capable of being flexibly manipulated, while retaining the desired display characteristics.

An advantage of the present disclosure is that a capability is provided to selectively vary a number of properties of a venue in a manner that varies the visual and/or audio presentations of an event at the venue.

Further aspects of the present invention are disclosed herein. The features as discussed above, as well as other features and advantages of the present disclosure, will be appreciated and understood by those skilled in the art from the following detailed description and drawings.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a front perspective view of several units of one embodiment of the suspended surface assembly of the present invention.

FIG. 2 is a side perspective view of the several units of the suspended surface assembly shown in FIG. 1 and showing a scrim curtain of each suspended surface assembly in a completely wound-up condition and suspended with the top lengthwise end thereof raised to a maximum height.

FIG. 3 is a front view of several units of the suspended surface assembly deployed relative to a stage arrangement.

FIG. 4 is an enlarged perspective view of the lift complex of one unit of the one embodiment of the suspended surface assembly of the present invention shown in FIG. 1.

FIG. 5A is an enlarged partially exploded perspective view of the downstream junction box of one unit of the one embodiment of the suspended surface assembly of the present invention shown in FIG. 1.

FIG. 5B is an enlarged partially exploded perspective view of the upstream junction box of one unit of the one embodiment of the suspended surface assembly of the present invention shown in FIG. 1.

FIG. 6 is a perspective view of a portion of a variation of the suspended surface assembly of the present invention.

FIG. 7 is a perspective view of a portion of a variation of the suspended surface assembly of the present invention.

FIG. 8 is a perspective view of a portion of a variation of the suspended surface assembly of the present invention.

FIG. 9 is a front plan view of the several units of the suspended surface assembly shown in FIG. 2 with the scrim curtain of each suspended surface assembly in a completely wound-up condition and suspended with the top lengthwise end thereof raised to a maximum height.

FIG. 10 is an enlarged partially exploded perspective view of the downstream junction box of the variation of the suspended surface assembly shown in FIG. 6.

FIG. 11 is a schematic exploded perspective view of a commercially available roll drop arrangement.

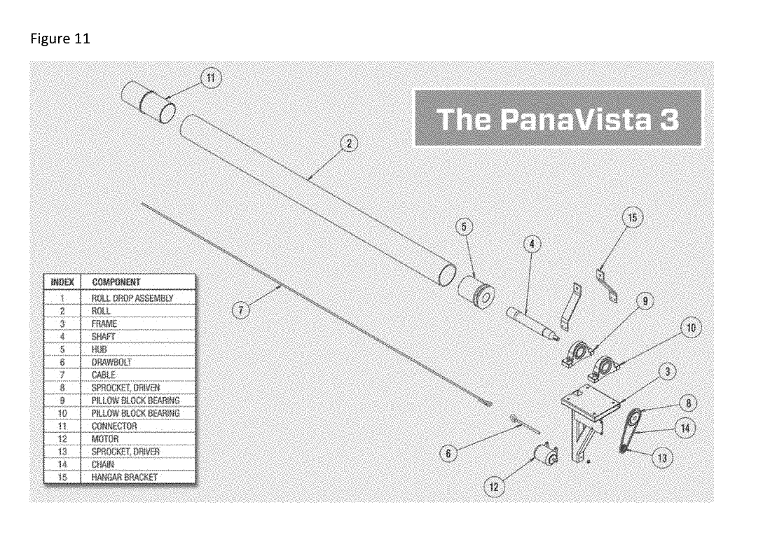

FIG. 12 is a perspective view of a commercially available roll drop arrangement shown in FIG. 11.

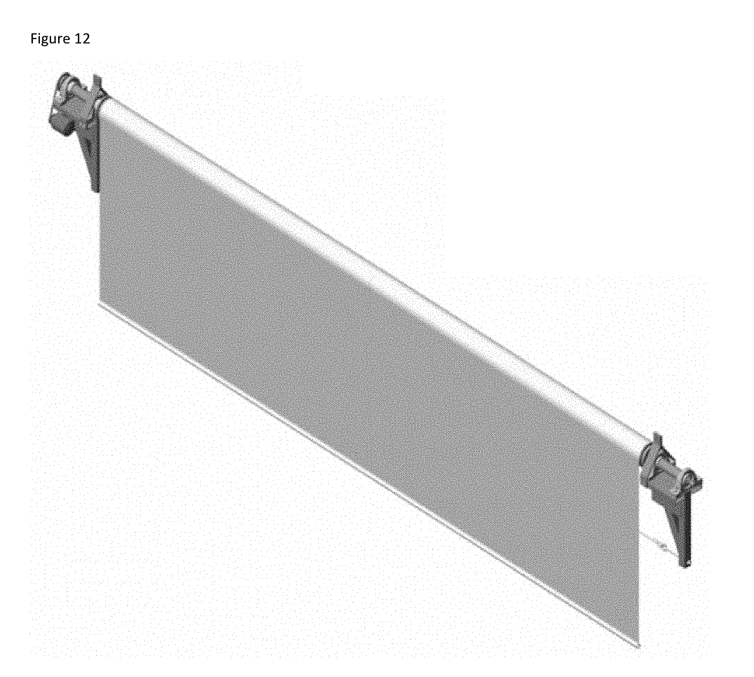

Wherever possible, the same reference numbers will be used throughout the drawings to represent the same parts.

### DETAILED DESCRIPTION OF THE INVENTION

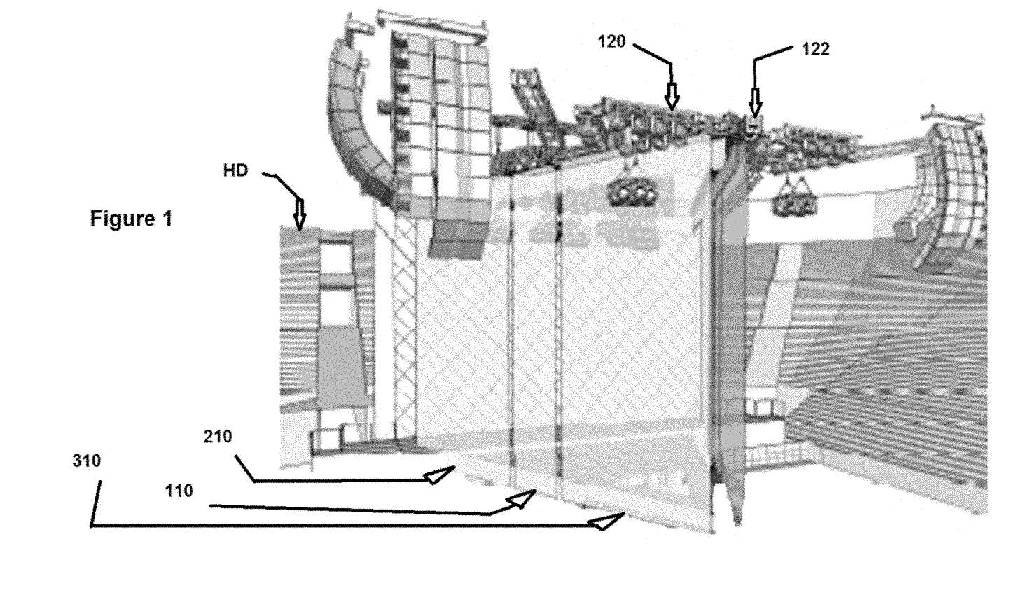

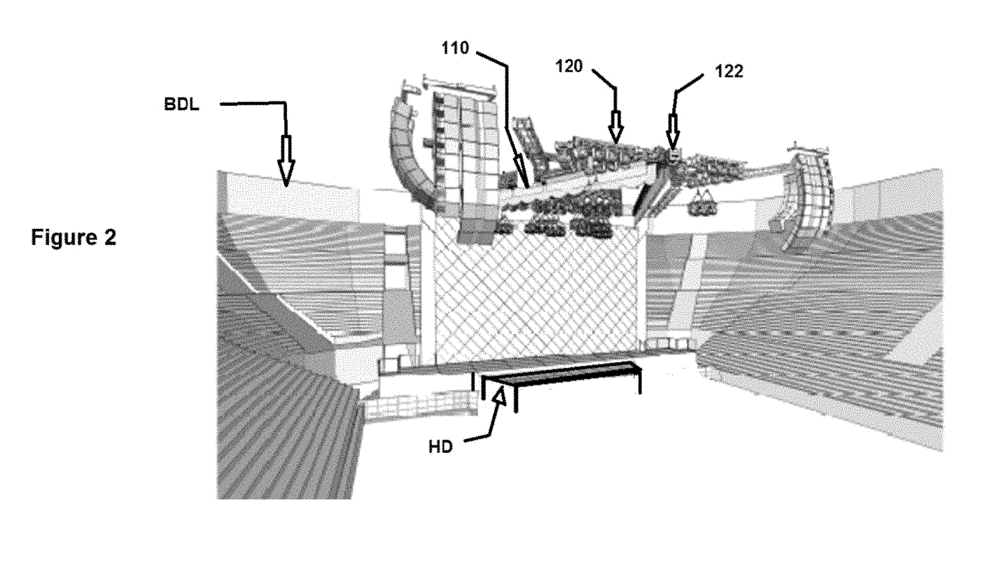

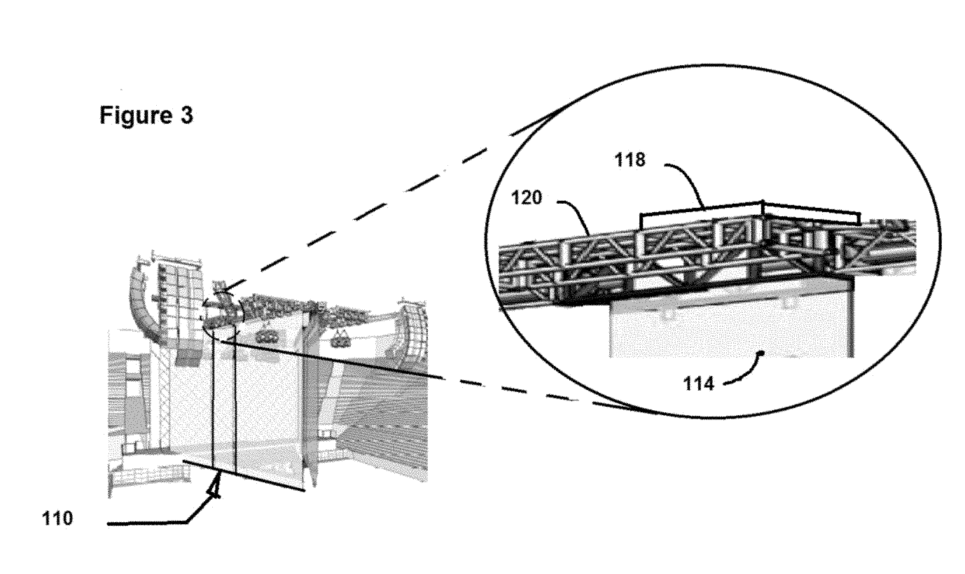

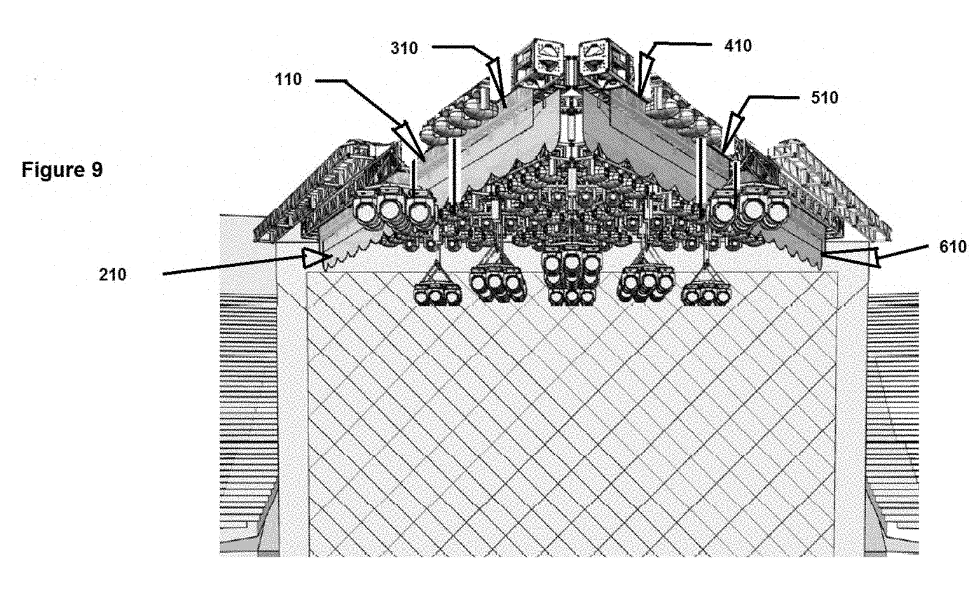

Reference is now had to FIGS. 1-10 in connection with a detailed description of the suspended surface assembly of the present invention. FIG. 1 is a front perspective view of several units of one embodiment of the suspended surface assembly and the units of the suspended surface assembly are deployed in connection with a stage arrangement at a performance space or venue. Each unit of the suspended surface assembly includes a scrim curtain that is windable onto a core and unwindable therefrom to a fully unwound condition in which the scrim curtain may operate in a customary or conventional role as a scrim curtain or an olio or may otherwise operate as a visual display surface. FIG. 1 shows that each unit of the suspended surface assembly has its scrim curtain disposed in a fully unwound condition and suspended with the top lengthwise end thereof raised to a maximum height. FIG. 2 is a side perspective view of the several units of the suspended surface assembly shown in FIG. 1 and showing a scrim curtain of each suspended surface assembly in a completely wound-up condition and suspended with the top lengthwise end thereof raised to a maximum height. FIG. 3 is an enlarged front perspective view of a portion of a single unit of the suspended surface assemblies shown in FIG. 1, wherein the respective suspended surface assembly is in a fully unwound condition. FIG. 9 is a front plan view of the several units of the suspended surface assembly shown in FIG. 2 with the scrim curtain of each suspended surface assembly in a completely wound-up condition and suspended with the top lengthwise end thereof raised to a maximum height.

The suspended surface assembly can be deployed, for example, in an outdoor arena or a stage arrangement located at an outdoor venue such as, for example, a stadium with a plurality of seats oriented for audience members to see and hear a performance that is performed at the venue. The suspended surface assembly can also be deployed at a performance space located in, for example, a theater or an auditorium. Solely for exemplary purposes, a venue is representatively shown in FIGS. 1-3 as a building structure in the form of an outdoor stadium BDL. FIG. 3 shows several units of the suspended surface assembly deployed relative to a stage arrangement, wherein the stage arrangement, as best seen in FIG. 2, includes a planar horizontal deck HD erected in a bowl area of a stadium, with the stadium having a plurality of seats oriented for audience members to see and hear a performance that is performed by performers supported on the planar horizontal deck HD of the stage arrangement. One of the units of the suspended surface assembly—a suspended surface assembly 110—will be described in more detail herein, and it is to be understood that the other units of the suspended surface assembly shown in FIG. 1—namely, as seen in FIG. 9, a suspended surface assembly 210, a suspended surface assembly 310, a suspended surface assembly 410, a suspended surface assembly 510, and a suspended surface assembly 610—are similarly configured to, and operate similar to, the suspended surface assembly 110.

The suspended surface assembly 110 has a spindle component particularly configured for training of a trainable surface support element therearound, wherein the term “trainable” is to be understood as a property of an element to be wound onto itself, whereupon the element is in a wound-up condition, and to be unwound from its wound-up condition to then either be in a partially unwound condition or a fully unwound condition. The trainable surface support element delimits a surface that is correspondingly in a furled or wound-up condition when the trainable surface support element is in its wound-up condition and that is correspondingly partially or fully unfurled or unwound in correspondence with the respective partially unwound condition or fully unwound condition of the trainable surface support element.

The spindle component onto which the trainable surface support element is trainable is exemplarily shown as a hollow core cylindrical batten 112, as shown, for example, in FIG. 3. The batten 112 is elongate and has a suitable surface along its longitudinal extent for securing a portion of the trainable surface support element to the batten or, alternatively, for receiving the trainable surface support element laid thereon to form the innermost winding of the trainable surface support element as the trainable surface support element is trained onto the batten 112.

The trainable surface support element may include, for example, a natural material, a synthetic material, or a hybrid natural and synthetic material such as, for example, an extent of fabric, that delimits a surface, and the fabric extent may have a significantly reduced thickness dimension relative to its height dimension and width dimension, whereupon the fabric extent is readily trainable around the batten 112. Solely for exemplary purposes in connection with a description of the suspended surface assembly 110, the trainable surface support element is shown as a fabric extent supported on a backbone grid and these elements together form a scrim curtain 114. The fabric extent of the scrim curtain 114 forms a surface having a base design operable to operate as a visual display for viewing by an audience present in a venue such as, e.g., the stadium shown in FIG. 1. Alternatively, the fabric extent of the scrim curtain 114 can form a surface onto which can be projected or otherwise transitorily displayed an image or other media feature.

The batten 112 is configured to be secured to a take-up action module 116 that itself is configured to be mounted in a suspended disposition from a lift complex 118. The lift complex 118 is mountable to a suitable portion of the respective venue in which the suspended surface assembly 110 is deployed such as, for example, a portion of the ceiling or the roof support structure of an enclosed building or a truss structure in an outdoor venue. Solely for exemplary purposes in connection with a description of the suspended surface assembly 110, the lift complex 118, as shown in FIG. 2, includes several independently operable sub-assemblies each of which is mounted to a respective one of a pair of truss structures 120, 122 in the stadium BDL shown in FIG. 1 and FIG. 2. The truss structures 120, 122 delimit an angle of an imaginary triangle with the suspended surface assembly 110, the suspended surface assembly 210, and the suspended surface assembly 310 being aligned along one respective side of the imaginary triangle that delimits the angle in cooperation with another side of the imaginary triangle, and the suspended surface assembly 410, the suspended surface assembly 510, and the suspended surface assembly 610 being aligned along the other respective side of the triangle delimiting the angle. The take-up action module 116 is configured to drivingly rotate the batten 112 around a central longitudinal axis of the batten to thereby effect winding of the scrim curtain 114 onto the batten or to effect unwinding of the scrim curtain 114 from its partially or fully wound-up condition, with this driving rotation of the batten 112 occurring partially or fully during a period of time that the batten 112 is maintained at the same selected vertical elevation or partially or fully during a period of time that the batten 112 is raised and/or lowered to and between a series of vertical waypoints. The batten 112 and the scrim curtain 114 form a switch out display sub-assembly that can be switched out of its mounting with the take-up action module 116 for replacement thereof by another switch out display sub-assembly such as, for example, another scrim curtain trainable around the batten 112. The lift complex 118 is operable to controllably raise the batten 112, the scrim curtain 114, and the take-up action module 116 via a step of moving these components relatively toward the truss structure 120 in a vertical direction and to controllably lower these elements via a step of moving them relatively away from the truss structure 120 in a vertical direction.

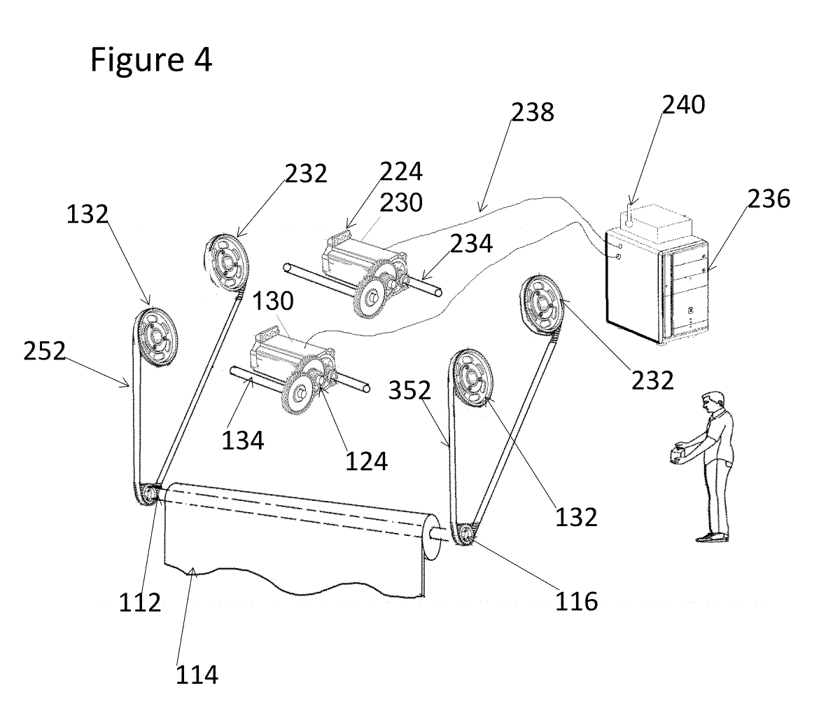

As seen in FIG. 4, which is an enlarged perspective view of the lift complex 118, the lift complex 118 includes a right-hand winch 124 that is supported at a horizontal posture on the truss structure 120. The lift complex 118 also includes a pair of right-hand gear boxes 130 each comprising a right-hand transfer gear 132 mounted on a respective one of a pair of output shafts 134 drivingly connected to the right-hand winch 124. The right-hand transfer gear 132 of each right-hand gear box 130 is rotatably mounted to a mounting frame of the right-hand gear box via a journal bearing sub-assembly (not shown), whereupon each right-hand transfer gear 132 is drivingly rotated relative to its right-hand gear box 130 via a rotation movement of the respective output shaft 134 in correspondence with driving rotation of the output shaft 134 via the right-hand winch 124.

As further seen in FIG. 4, the lift complex 118 includes a left-hand winch 224 that is supported at a horizontal posture on a truss structure. The lift complex 118 also includes a pair of left-hand gear boxes 230 each comprising a left-hand transfer gear 232 mounted on a respective one of a pair of output shafts 234 drivingly connected to the left-hand winch 224. The left-hand transfer gear 232 of each left-hand transfer gear box 230 is rotatably mounted to a mounting frame of the left-hand gear box via a journal bearing sub-assembly (not shown), whereupon each left-hand transfer gear 232 is drivingly rotated relative to its left-hand gear box 230 via a rotation movement of the respective output shaft 234 in correspondence with driving rotation of the output shaft 234 via the left-hand winch 224.

A control box 236 is operatively connected via conduits 238 to each of the right-hand winch 124 and the left-hand winch 224 and the control box 236 is connected via a wireless control communication element 240 to a control input module 242 via which an operator can control the operation of the control box 236 to effect coordinated movement of the raising and lowering movement of the take-up action module 116 as well as the winding up and unwinding movement of the scrim curtain 114.

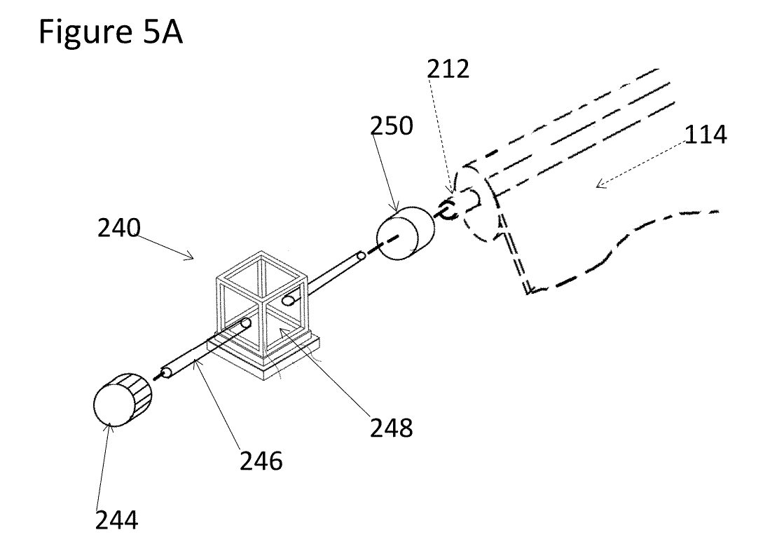

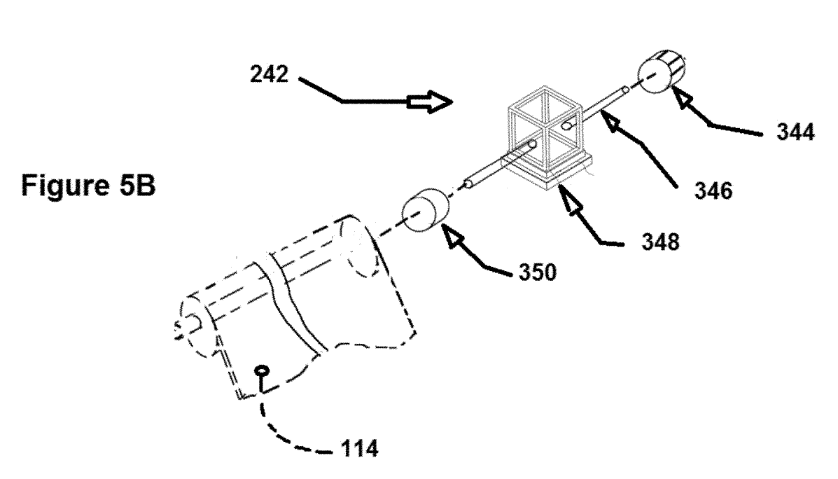

The take-up action module 116 includes a communication element 240 and a control input module 242. As seen in FIG. 5A, which is an enlarged partially exploded perspective view of the communication element 240, the communication element 240 includes a driven toothed gear 244 fixedly mounted to one axial end of a free spinning shaft 246 that is rotatably mounted in a journal bearing (not shown) secured in a frame 248. A hub coupling 250 is fixedly mounted to the opposite axial end of the free spinning shaft 246 and includes a closed end cylindrical bore configured to receive an axial end portion of the batten 212 inserted therein and to secure the batten 212 relative to the shaft such that rotation of the free spinning shaft 246 effects corresponding rotation of the batten 212.

A downstream pulley belt 252 has one axial end secured to a respective one of the right-hand transfer gears 132, is trained around the driven toothed gear 244, and has its opposite axial end secured to a respective one of the left-hand transfer gears 232.

As seen in FIG. 5B, which is an enlarged partially exploded perspective view of the upstream junction box, the control input module 242 includes a driven toothed gear 344 fixedly mounted to one axial end of a free spinning shaft 346 that is rotatably mounted in a journal bearing (not shown) secured in a frame 348. A hub coupling 350 is fixedly mounted to the opposite axial end of the free spinning shaft 346 and includes a closed end cylindrical bore configured to receive an axial end portion of the batten 212 inserted therein and to secure the batten 212 relative to the shaft such that rotation of the free spinning shaft 346 effects corresponding rotation of the batten 212.

An upstream pulley belt 352 has one axial end secured to a respective one of the right-hand transfer gears 132, is trained around the driven toothed gear 344, and has its opposite axial end secured to a respective one of the left-hand transfer gears 232.

The control box 236 is operable to selectively drive the rotation of selected ones of the right-hand transfer gears 132 and the left-hand transfer gears 232, and to selectively prevent rotation of selected ones of the right-hand transfer gears 132 and the left-hand transfer gears 232, with such driving rotation and rotation prevention activities being coordinated so as effect selected raising and lowering movement of the take-up action module 116 as well as selected winding up and unwinding movement of the scrim curtain 114.

As seen in FIG. 4, the control box 236 can be operated by a user to selectively drive the rotation of both of the right-hand transfer gears 132 in a counter-clockwise direction and to selectively drive the rotation of both of the left-hand transfer gears 232 in a clockwise direction, with the speeds of rotation of the right-hand transfer gears 132 and the left-hand transfer gears 232 being coordinated that the downstream pulley belt 252 and the upstream pulley belt 352 are wound onto, or unwound from, these transfer gears and, correspondingly, rotative movement is transmitted via the driven toothed gears 244, 344 to the batten 112 and/or the batten 112, the scrim curtain 114, and the take-up action module 116 are raised or lowered.

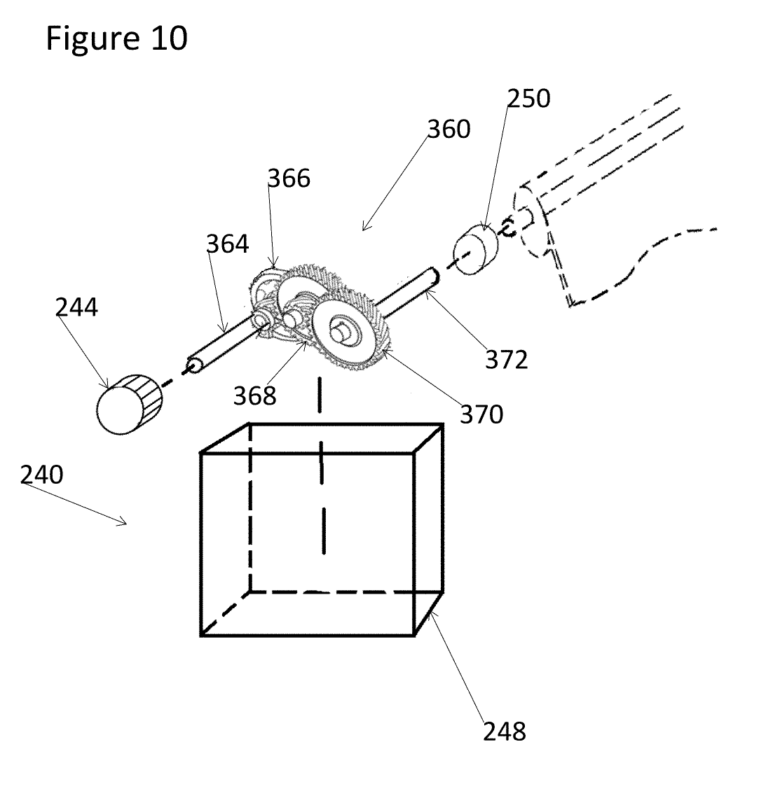

Reference is now had to FIG. 10 in connection with a description of a variation of the suspended surface assembly 110. As seen in FIG. 10, which is an enlarged partially exploded perspective view of the downstream junction box of this variation of the suspended surface assembly 110, the frame 248 of the communication element 240 supports a transmission gear assembly 360 comprising a plurality of mating gears 368 each of which is rotatably supported on the frame 248. In lieu of the free spinning shaft 246, an input shaft 364 is provided and the driven toothed gear 244 is secured to one axial end of the input shaft 364 and an input gear 366 is secured to an opposite axial end of the input shaft 364. The input gear 366 meshingly engages the mating gears 368. An outlet gear 370 meshingly engages the mating gears 368 and is secured to one axial end of an output shaft 372. The hub coupling 250 is secured to the opposite axial end of the output shaft 372.

Although not illustrated, in connection with the variation of the suspended surface assembly 110, the upstream junction box 340 is configured similar to the communication element 240 in that the upstream junction box 340 includes a transmission gear assembly.

As the respective ones of the downstream pulley belt 252 and the upstream pulley belt 352 are wound onto, or unwound from, the right-hand transfer gears 132 and the left-hand transfer gears 232, respectively, rotation movement is transmitted via the driven toothed gears 244, 344 to the batten 112 and/or the take-up action module 116, and the batten 112 and the scrim curtain 114 are raised or lowered as a single unit. In this connection, the transmission gear assembly of the communication element 240 and the transmission gear assembly of the upstream junction box 340 reduce or increase the rate of rotation of the batten 112 relative to the driven toothed gear 244 or transfer an identical rate of rotation to the batten 112 as the rate of rotation of the driven toothed gear 244, 344.

The transmission gear assembly of the communication element 240 and the transmission gear assembly of the upstream junction box 340 may be configured to operate with a predetermined gear ratio, whereupon the scrim curtain 114 will be wound onto, or unwound from, the batten 112 at a predetermined rate and whereupon the scrim curtain 114 will be disposed at a given height within a predetermined range of heights (with the top edge of the scrim curtain 114 being continuously secured to, or located at, the batten 112 and the height of the batten 112 consequently determining the height of the top edge of the scrim curtain 114). Alternatively, an appropriate variable control arrangement may be provided to allow a user to select the timing and the deployed lengths of the winding up movements and the unwinding movements of the scrim curtain 114 and the vertical locations at which the batten 112, and consequently the top edge of the scrim curtain 114, will be disposed. For example, a clutch arrangement (not shown) can be operatively coupled to each of the transmission gear assembly of the communication element 240 and the transmission gear assembly of the upstream junction box 340 so that the rotational output of each transmission gear assembly can be selectively coupled to, or de-coupled from, the right-hand transfer gears 132 and the left-hand transfer gears 232, respectively.

Among the advantages of the variation of the suspended surface assembly 110 shown in FIG. 10 is the advantage that a separate motor or other separate motive drive for driving the rotation of the batten 112 can be omitted, for the reason that the motive force for effecting driving rotation of the batten 112 can be provided entirely via the respective motive force that also drives the rotation of the downstream pulley belts 252 and the upstream pulley belts 352—namely, the motive force provided by the right-hand winch 124 and the left-hand winch 224. Consequently, the attendant additional mass and inertia forces that would be present if a separate motor or other separate motive drive for driving the rotation of the batten 112 were, in fact, provided, are avoided and this is particularly beneficial in that the suspended mounting arrangement and the material composition and structure of the batten 112 can be accordingly streamlined, as the batten 112 of the suspended surface assembly 110 does not need to support or handle such attendant additional mass and inertia forces as would be the case if a separate motor or other separate motive drive for drivingly rotating the batten 112, were mounted adjacent the batten 112. Instead, the motive force for driving rotation of the batten 112 is transmitted via the transmission gear assembly 360 of the communication element 240 and the transmission gear assembly of the upstream junction box 340 and so the batten 112 need only accommodate the mass and inertia forces of mass and inertia forces of the communication element 240 and the upstream junction box 340. As the communication element 240 and the upstream junction box 340 are not coupled or electrically connected to a power source—as contrasted with a separate motor or other separate motive drive for driving the rotation of the batten 112, which would require a power supply arrangement—there is also an additional savings in the reduction of mass as well as a reduction in the operating complexity and the deployment complexity of the suspended surface assembly 110.

In further connection with the advantages noted with regard to the variation of the suspended surface assembly 110 shown in FIG. 10, two or more of the suspended surface assemblies 110, 210, and 310 can be commonly ganged to, or otherwise operatively associated with, a common motive power source. For example, a single winch can wind and unwind groups of cables that each are coupled to a respective one of the suspended surface assemblies 110, 210, and 310, whereupon the vertical movements and the winding and unwinding activities of all of the suspended surface assemblies 110, 210, and 310 can be driven via this single winch.

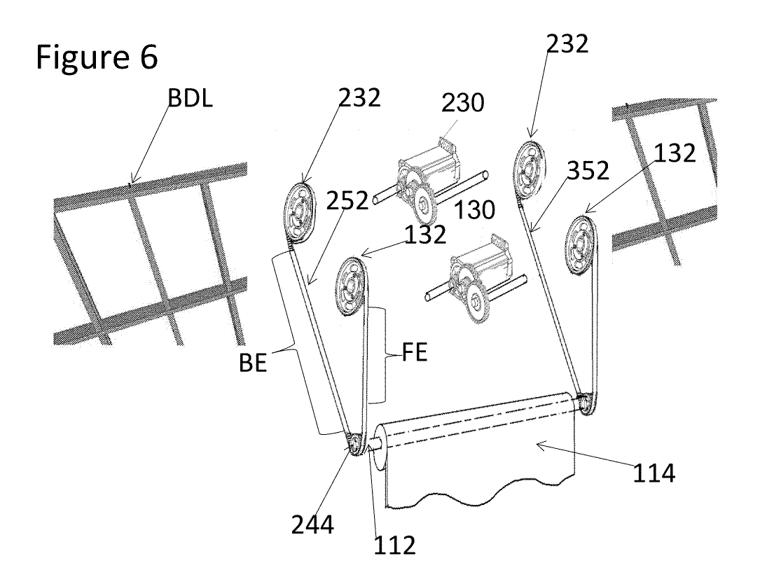

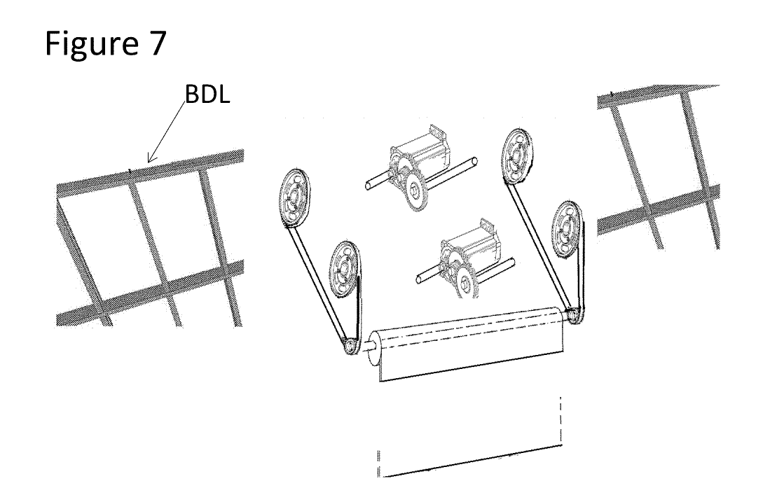

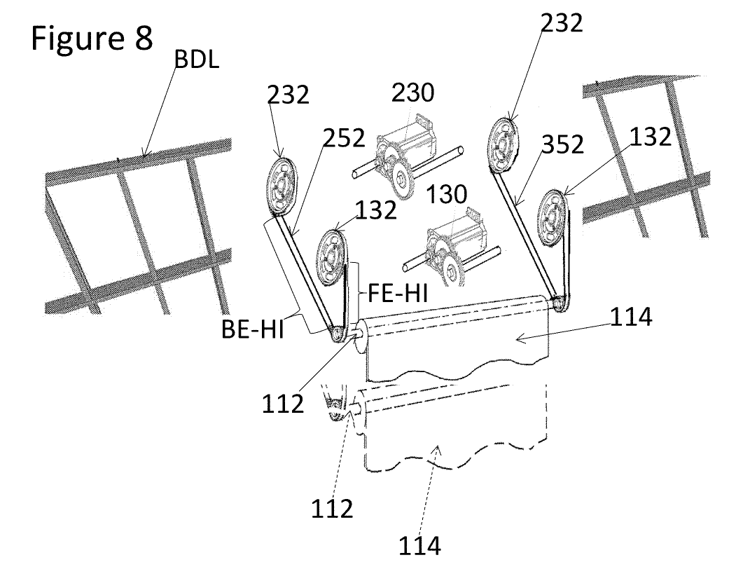

Reference is had to FIG. 6, FIG. 7, and FIG. 8 in connection with a description of an exemplary movement sequence that the control box 236 can control in accordance with instructions from a user. As seen in FIG. 6, which is a perspective view of a portion of the variation of the suspended surface assembly 110 shown in FIG. 10, the suspended surface assembly 110 is shown in a deployed status in the stadium BDL. The downstream pulley belts 252 and the upstream pulley belts 352 have been operated under the control of the control box 236 to position the batten 112 at a predetermined suspended disposition and the batten 112 is thereafter maintained at this predetermined suspended disposition via ceasing the rotation movements of the right-hand transfer gears 132 and the left-hand transfer gears 232 that take up or unwind the downstream pulley belts 252 and the upstream pulley belts 352, respectively. When the rotation movements of the downstream pulley belts 252 and the upstream pulley belts 352 are ceased, the downstream pulley belt 252 and the upstream pulley belt 352, each of which extends from a respective one of the right-hand transfer gears 132, around a respective one of the driven toothed gear 244 and the driven toothed gear 344, and thereafter onto a respective one of the left-hand transfer gears 232, are each characterized by a front extent FE and a back extent BE. The front extent FE of each of the downstream pulley belt 252 and the upstream pulley belt 352 extends from a tangent delimited by the pulley belt at the location at which it feeds onto the respective one of the right-hand transfer gears 132 on which it is trained to a tangent delimited by the pulley belt at the location at which it feeds onto the respective one of the driven toothed gear 244 and the driven toothed gear 344 on which it is trained. The back extent BE of each of the downstream pulley belt 252 and the upstream pulley belt 352 extends from a tangent delimited by the pulley belt at the location at which it feeds onto the respective one of the left-hand transfer gears 232 on which it is trained to a tangent delimited by the pulley belt at the location at which it feeds onto the respective one of the driven toothed gear 244 and the driven toothed gear 344 on which it is trained.

As seen in FIG. 8, which is a perspective view of a portion of the variation of the suspended surface assembly 110 shown in FIG. 10, the suspended surface assembly 110 is shown in a deployed status in the stadium BDL at a time at which the batten 112 has been raised from its position shown in FIG. 6 to a new higher position, all while the scrim curtain 114 has been maintained at the same unfurled length that it had during the time during which the batten 112 was maintained at the position shown in FIG. 6 (in other words, no unwinding or winding up of the scrim curtain 114 has occurred during the vertical movement of the batten 112 between the initial position thereof shown in FIG. 6 to the new higher position shown in FIG. 8). The initial position of the batten 112 (at which it was maintained as discussed with respect to FIG. 6) is shown in broken lines in FIG. 8. The downstream pulley belt 252 and the upstream pulley belt 352 in the new higher position of the batten 112 shown in FIG. 8 are each characterized by a front extent FE-HI and a back extent BE-HI that are each, respectively, less than the front extent FE and the back extent BE of these pulley belts in the initial position of the batten 112 (at which it was maintained as discussed with respect to FIG. 6).

As seen in FIG. 7, which is a perspective view of a portion of the variation of the suspended surface assembly 110 shown in FIG. 10, the suspended surface assembly 110 is shown in a deployed status in the stadium BDL at a time at which the batten 112 is maintained in its initial position shown in FIG. 6 and after the scrim curtain 114 has been wound up onto the batten 112, after the scrim curtain 114 had been at a relatively longer length at the position of the batten 112 shown in FIG. 6, to a new reduced length that is less than its length at the position of the batten 112 shown in FIG. 6. To achieve a winding up of the scrim curtain 114 onto the batten 112 while the batten 112 is maintained in its initial position shown in FIG. 6, the control box 236 controls the rate or speed of rotation and the duration of rotational periods and non-rotational periods of the right-hand transfer gears 132 and the left-hand transfer gears 232 to thereby bring about appropriate movement of the downstream pulley belt 252 and the upstream pulley belt 352 which, in turn, effect rotation of the driven toothed gear 244 and the driven toothed gear 344, and thereby rotation of the batten 112, while not imparting a raising movement or a lowering movement to the batten 112. The position of the scrim curtain 114 when it has a relatively longer length at the position of the batten 112 as has been discussed in connection with FIG. 6 is shown in FIG. 7 in broken lines. The scrim curtain 114 has been wound up onto the batten 112 from its relatively longer length at the position of the batten 112 shown in FIG. 6 to a new relatively shorter length as shown in solid lines in FIG. 7.

The disclosure of an embodiment of the suspended surface assembly of the present invention herein has described a toothed gear configuration that cooperates with a pulley belt having teeth for engaging the toothed gears. It is noted that a smooth surface pulley and a smooth surface belt configuration can be deployed in lieu of the toothed gear and pulley belt with teeth configuration.

It is important to note that the construction and arrangement of the suspended surface assembly and the method, as shown in the exemplary embodiment and the variations described herein, are illustrative only. Although only a single exemplary embodiment has been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

The present application contemplates the deployment of any suitable methods, systems, or program products on any machine-readable media that may assist in the design, configuration, manufacture, or operation of the apparatus and methods of the present invention. The embodiments of the present application may be implemented using an existing computer processor, or by a special purpose computer processor for an appropriate system, incorporated for this or another purpose or by a hardwired system.

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium.

Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

The present application is not limited to a particular embodiment, but extends to various modifications that nevertheless fall within the scope of the appended claims. The order or sequence of any processes or method steps may be varied or re-sequenced according to alternative embodiments.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A suspended surface assembly comprising:
a trainable surface support element;
a spindle component configured for training of the trainable surface support element therearound;
a take-up action module configured to drivingly rotate the spindle component to thereby effect winding of the trainable surface support element onto the spindle component or to effect unwinding of the trainable surface support element from a partially or fully wound-up condition; and
a lift complex for adjusting the vertical position of the trainable surface support element and the spindle component, the lift complex including a motive power element operable to both drivingly rotate the spindle component and to drivingly raise and lower the trainable surface support element and the spindle component.

2. A method of deploying a suspended surface assembly, the method comprising:
providing a suspended surface assembly having a trainable surface support element, a spindle component configured for training of the trainable surface support element therearound, a take-up action module configured to drivingly rotate the spindle component to thereby effect winding of the trainable surface support element onto the spindle component or to effect unwinding of the trainable surface support element from a partially or fully wound-up condition, and a lift complex for adjusting the vertical position of the trainable surface support element and the spindle component, the lift complex including a motive power element operable to both drivingly rotate the spindle component and to drivingly raise and lower the trainable surface support element and the spindle component; and
operating the motive power element to both drivingly rotate the spindle component and to drivingly raise and lower the trainable surface support element and the spindle component.
